(19) United States
(12) Patent Application Publication
(10) Pub. No.: US 2025/0229615 A1
(43) Pub. Date: Jul. 17, 2025

(54) LABYRINTH SEAL FOR GARNISH PANEL

(71) Applicant: Honda Motor Co., Ltd., Tokyo (JP)

(72) Inventors: Patrick W. KRUSE, Marysville, OH (US); David J. Rose, West Mansfield, OH (US); Jeffrey D. Wheeland, Radnor, OH (US); Hirofumi Takemoto, Dublin, OH (US)

(21) Appl. No.: 18/414,642

(22) Filed: Jan. 17, 2024

(51) Int. Cl. B60J 10/86; B60R 13/02

(52) U.S. Cl. CPC B60J 10/86; B60R 13/02

(57) ABSTRACT

A garnish seal for a vehicle includes an elongate main body configured to be mounted on an inner side of a garnish panel. The garnish seal further includes an elongate sealing element extending along the elongate main body and protruding in a direction away from the main body, the sealing element being configured to seal against a body of a vehicle on which the garnish panel is mounted. In addition, the seal includes a forward flange protruding away from a forward portion of the main body when the garnish seal is mounted on the vehicle and configured to seal against the body of the vehicle in a forward portion of the garnish panel; and an upper flange extending along a portion of a length of the main body substantially parallel to the sealing element, defining a channel between the upper flange and the sealing element.

### BACKGROUND

### 1. Field of the Disclosure

The present disclosure relates to a seal for an automotive garnish panel and, more particularly, to a garnish seal having a built-in labyrinth.

### 2. Description of Related Art

Many automobiles and other motorized vehicles include panels that enhance the appearance and/or functionality of the vehicle body. These panels are referred to as garnish panels or simply “garnishes.” Garnishes are often placed at the edges of body panels, for example adjacent windows. There are typically one or more small spaces between a garnish and the body of the vehicle. When the vehicle is traveling, air flows past the garnish as it passes over the vehicle body. In some cases, as high-speed airflow travels along the edge of a garnish, wind noise is created by low-speed air behind the garnish venting through a small gap due to pressure differences. This wind noise may be unpleasant to occupants in the vehicle cabin.

There is a need in the art for a garnish configuration that addresses one or more of the issues noted above.

### SUMMARY OF THE INVENTION

The present disclosure is directed to a garnish seal configured to reduce wind noise near a garnish attached to a side panel of a vehicle. The disclosed seal arrangement includes a labyrinth path for air venting behind the garnish, which reduces the speeds of air exiting from behind the garnish to thereby eliminate or significantly reduce wind noise produced during vehicle travel.

In one aspect, the present disclosure is directed to a garnish seal for a vehicle. The garnish seal may include an elongate main body configured to be mounted on an inner side of a garnish panel; an elongate sealing element extending along the elongate main body and protruding in a direction away from the main body, the sealing element being configured to seal against a body of a vehicle on which the garnish panel is mounted; a forward flange protruding away from a forward portion of the main body when the garnish seal is mounted on the vehicle and configured to seal against the body of the vehicle in a forward portion of the garnish panel; and an upper flange extending along a portion of a length of the main body substantially parallel to the sealing element, defining a channel between the upper flange and the sealing element.

In another aspect, the present disclosure is directed to a garnish seal arrangement. The garnish seal arrangement may include a garnish panel configured to be mounted on a body of a vehicle and a garnish seal. The garnish seal may include an elongate main body configured to be mounted on an inner side of the garnish panel; an elongate sealing element extending along the elongate main body and protruding in a direction away from the main body, the sealing element being configured to seal against a body of a vehicle on which the garnish panel is mounted; a forward flange protruding away from a forward portion of the main body when the garnish seal is mounted on the vehicle and configured to seal against the body of the vehicle in a forward portion of the garnish panel; and an upper flange extending along a portion of a length of the main body substantially parallel to the sealing element, defining a channel between the upper flange and the sealing element.

In another aspect, the present disclosure is directed to a vehicle. The vehicle may include a vehicle body defining a structural periphery of the vehicle, and a garnish seal arrangement. The garnish seal arrangement may include a garnish panel configured to be mounted on the vehicle body and a garnish seal. The garnish seal may include an elongate main body configured to be mounted on an inner side of the garnish panel; an elongate sealing element extending along the elongate main body and protruding in a direction away from the main body, the sealing element being configured to seal against a body of a vehicle on which the garnish panel is mounted; a forward flange protruding away from a forward portion of the main body when the garnish seal is mounted on the vehicle and configured to seal against the body of the vehicle in a forward portion of the garnish panel; and an upper flange extending along a portion of a length of the main body substantially parallel to the sealing element, defining a channel between the upper flange and the sealing element.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a schematic rear view of a vehicle including a D-pillar garnish;

FIG. 2 is a schematic right side view of the vehicle shown in FIG. 1;

FIG. 3 is a schematic illustration of a prior art garnish seal arrangement looking from the right side of the vehicle body outward toward the right of the vehicle (i.e., looking at the inside surfaces of a prior art right side D-pillar garnish);

FIG. 4 is a schematic cross-sectional view of the prior art garnish seal arrangement of FIG. 3 taken at line 4-4 in FIG. 3;

FIG. 5 is a schematic illustration of a garnish seal arrangement looking from the right side of the vehicle body outward toward the right of the vehicle (i.e., looking at the inside surfaces of a right side D-pillar garnish);

FIG. 6 is a schematic cross-sectional view of the garnish seal arrangement of FIG. 5 taken at line 6-6 in FIG. 5;

FIG. 7 is a schematic perspective view of the prior art garnish seal shown in FIGS. 3 and 4; and

FIG. 8 is a schematic perspective view of the garnish seal shown in FIGS. 5 and 6.

### DETAILED DESCRIPTION

According to some aspects, the present disclosure is directed to a vehicle. The vehicle may include a vehicle body defining a structural periphery of the vehicle. As shown in the accompanying figures and discussed in greater detail below, the vehicle may include a garnish panel configured to be mounted on the vehicle body.

The garnish panel may be configured to be mounted on any suitable portion of the vehicle body. For example, in some embodiments, the garnish seal arrangement is configured to be mounted in a D-pillar region of the vehicle body. A D-pillar of a vehicle is a known region of a vehicle body extending between a quarter window and a tailgate of a four-door vehicle with a rear hatch. Exemplary such vehicles may include Sport Utility Vehicles (SUV's), wagons, cross-overs, and other vehicles of similar constructions.

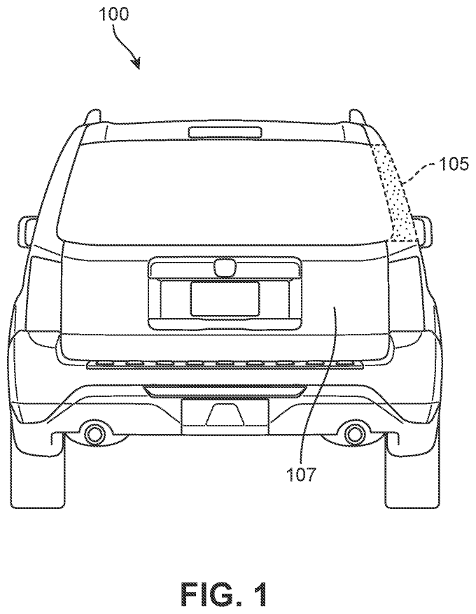

FIG. 1 is a schematic rear view of a vehicle including a D-pillar garnish. As shown in FIG. 1, a vehicle 100 may include a D-pillar garnish 105. D-pillar garnish may be located proximate a rear hatch 107 of vehicle 100.

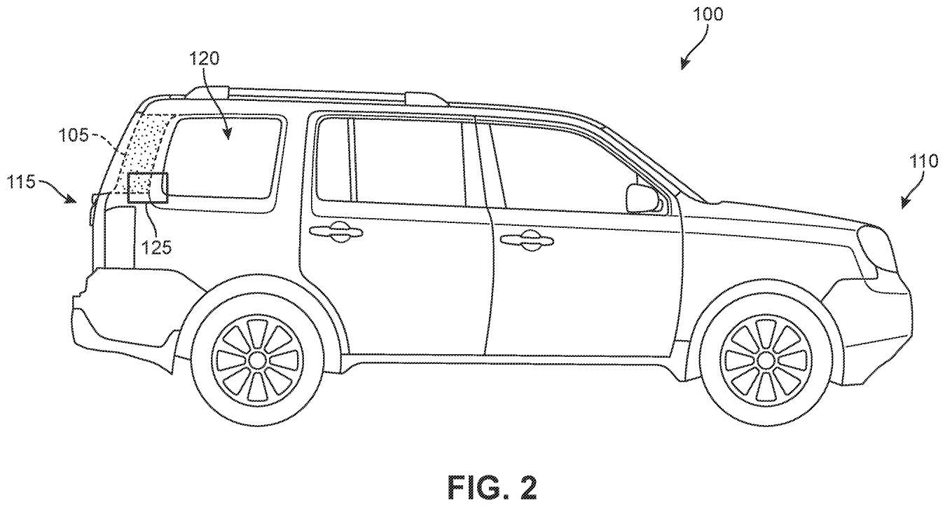

FIG. 2 is a schematic right side view of the vehicle shown in FIG. 1. As shown in FIG. 2, vehicle 100 has a front end 110 and a rear end 115. D-pillar garnish 105 is located toward rear end 115 of vehicle 100 proximate rear quarter window 120. Further, garnish 105 may include a garnish seal in a lower region 125 of garnish 105.

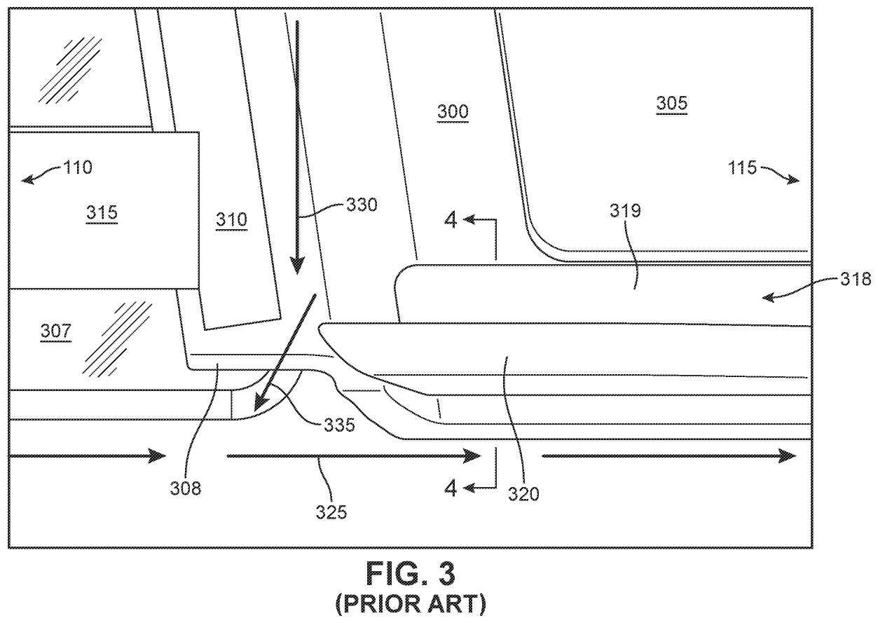

FIG. 3 is a schematic illustration of a prior art garnish seal arrangement looking from the right side of the vehicle body outward toward the right of the vehicle (i.e., looking at the inside surfaces of a prior art right side D-pillar garnish). Accordingly, front end 110 is reflected with an arrow to the left in FIG. 3, and rear end 115 is reflected with an arrow to the right. FIG. 3 also shows arrows 325, indicating airflow over the vehicle as air proceeds from front end 110 to rear end 115 of the vehicle.

As shown in FIG. 3, a garnish seal arrangement includes a garnish panel 300 and a garnish seal 318 mounted thereon. In some embodiments, garnish panel 300 includes an inner panel 305 facing the body of the vehicle. In addition, garnish panel 300 includes a forward flange 308 configured to fit on an inner side of rear quarter window 307. Forward flange 308 of garnish panel 300 is sealed against the body of the vehicle by a substantially vertically oriented first seal 310, and may also be associated with a second seal 315. First seal 310 and second seal 315 may be formed of a foam rubber material or other suitable material.

Prior art garnish seal 318 includes a main body 319 mounted on garnish panel 300 and a sealing element 320 extending along main body 319, protruding from main body 319, and configured to seal against the body of the vehicle at the bottom of garnish panel 300. In this configuration, air between the body of the vehicle and the inner surfaces of garnish panel 300 is drawn down in the direction of a first arrow 330 and then exits from behind garnish panel 300 in a direction indicated by a second arrow 335. Because the air traveling over the vehicle is moving faster than the air behind garnish panel 300, the air traveling over the vehicle has a lower pressure. Therefore, the air flows from the higher pressure behind the garnish panel 300 in the direction of second arrow 335 toward the lower pressure outside the vehicle. This flow of air out from behind prior art garnish panel 300 occurs at a relatively high speed, resulting in a whistling sound that is unpleasant for occupants of the vehicle.

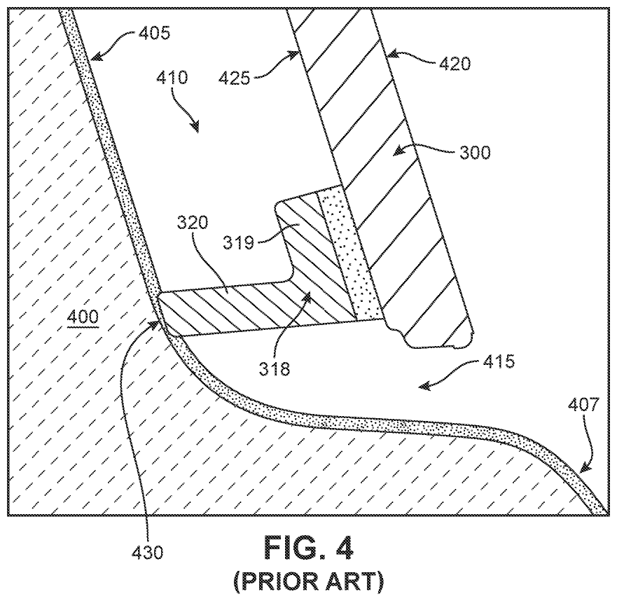

FIG. 4 is a schematic cross-sectional view of the prior art garnish seal arrangement of FIG. 3 taken at line 4-4 in FIG. 3. As shown in FIG. 4, sealing element 320 of garnish seal 318 may seal against a vehicle body 400. As shown, sealing element 320 abuts against a covered surface 405 of vehicle body 400 that resides behind garnish panel 300, thereby sealing at least one edge (in this case the lower edge) of garnish panel 300.

Garnish panel 300 includes an outer facing surface 420 and an inner facing surface 425. A first channel 410 is defined above garnish seal 318 between inner surface 425 of garnish panel 300 and covered surface 405 of vehicle body 400. A second channel 415 is defined below garnish seal 318 between garnish panel 300 covered surface 405.

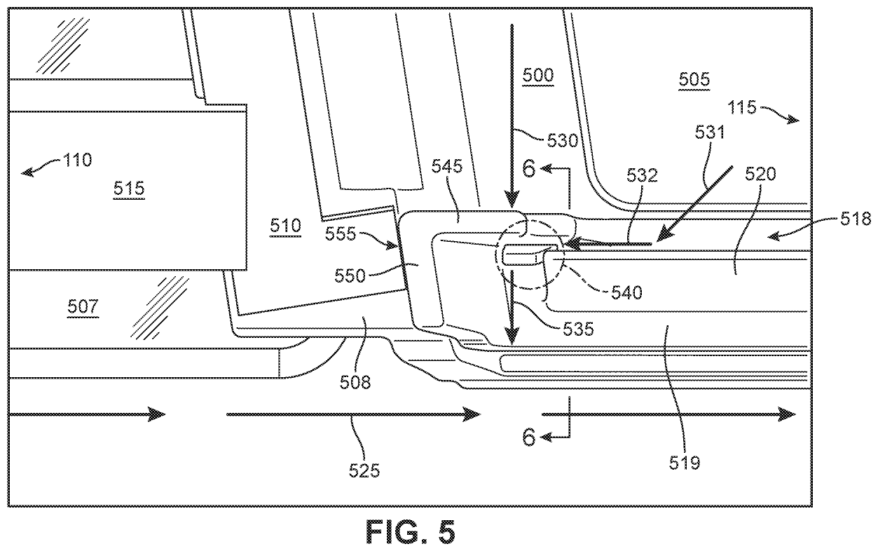

FIG. 5 is a schematic illustration of a garnish seal arrangement, according to an exemplary disclosed embodiment, looking from the right side of the vehicle body outward toward the right of the vehicle (i.e., looking at the inside surfaces of a right side D-pillar garnish). As shown in FIG. 5, front end 110 is reflected with an arrow to the left in FIG. 5, and rear end 115 is reflected with an arrow to the right. FIG. 3 also shows arrows 525, indicating airflow over the vehicle as air proceeds from front end 110 to rear end 115 of the vehicle.

As shown in FIG. 5, a garnish seal arrangement includes a garnish panel 500 and a garnish seal 518 mounted thereon. In some embodiments, garnish seal 518 may be formed of a material that is at least slightly compressible. The compressibility of garnish seal 518 may enable garnish seal 518 to seal against the body of a vehicle in an airtight or substantially airtight manner. Exemplary materials for garnish seal 528 may include rubber (natural or synthetic), foam rubber, compressible polymers, etc.

In some embodiments, garnish panel 500 includes an inner panel 505 facing the body of the vehicle. In addition, garnish panel 500 includes a forward flange 508 configured to fit on an inner side of rear quarter window 507. Forward flange 508 of garnish panel 500 is sealed against the body of the vehicle by a substantially vertically oriented first seal 510, and may also be associated with a second seal 515. First seal 510 and second seal 515 may be formed of a foam rubber material or other suitable material.

Garnish seal 518 includes an elongate main body 519 configured to be mounted on an inner side of garnish panel 500 and an elongate sealing element 520 extending along main body 519, protruding in a direction away from main body 519, and configured to seal against the body of the vehicle on which garnish panel 500 is mounted, in some cases at the bottom of garnish panel 500 as shown in FIG. 5. Garnish seal 518 also includes other features that creates a labyrinth for air to escape through in order to exit from behind garnish panel 500. As shown in FIG. 5, garnish seal 518 also includes a forward flange 550 protruding away from a forward portion of main body 519 when garnish seal 518 is mounted on the vehicle and configured to seal against the body of the vehicle in a forward portion of garnish panel 500. Forward flange 550 of garnish seal 518 is configured to substantially mate with forward flange 508 of garnish panel 500. In addition, garnish seal 518 includes an upper flange 545 extending along a portion of a length of main body 519 substantially parallel to sealing element 520, defining a channel between upper flange 545 and sealing element 520.

In the disclosed embodiment shown in FIG. 5, air between the body of the vehicle and the inner surfaces of garnish panel 500 does not escape between the front edge 555 of garnish seal 518 and first seal 510. Instead, forward flange 550 closes off this passageway, forcing air to flow out through the labyrinth formed by sealing element 520 and upper flange 545. Therefore, air flowing in the direction of arrow 530 is blocked by upper flange 545 and does not escape. The air is, instead, drawn along a tortuous pathway illustrated by arrows 531, 532, and 535, in order to escape from behind garnish panel 500. The air still flows from the higher pressure behind garnish panel 500 toward the lower pressure outside the vehicle. However, because the air must exit through this tortuous pathway of the labyrinth seal, the air escapes at slower speeds, reducing or eliminating the whistling sound that is unpleasant for occupants of the vehicle.

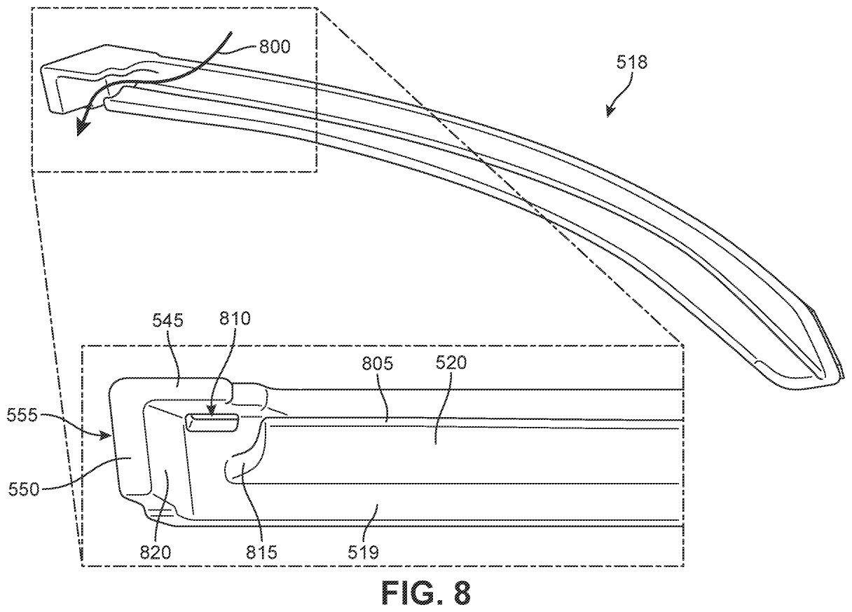

As also shown in FIG. 5, the garnish seal arrangement may include a locating feature configured to ensure alignment of the garnish seal in the proper position to regulate the flow of air in a manner described above that reduces or eliminates the unwanted noise. In particular, a locating feature 540 may project through an alignment opening in garnish seal 518. (See opening 810 in FIG. 8.)

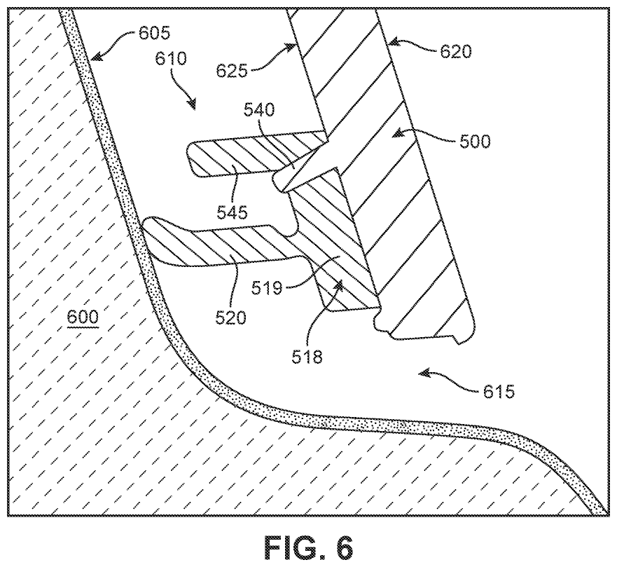

FIG. 6 is a schematic cross-sectional view of the garnish seal arrangement of FIG. 5 taken at line 6-6 in FIG. 5. As shown in FIG. 6, sealing element 520 of garnish seal 518 may seal against a vehicle body 600 defining a structural periphery of the vehicle. As shown, sealing element 520 abuts against a covered surface 605 of vehicle body 600 that resides behind garnish panel 500, thereby sealing at least one edge (in this case the lower edge) of garnish panel 500.

Garnish panel 500 includes an outer facing surface 620 and an inner facing surface 625. A first channel 610 is defined above garnish seal 518 between inner surface 625 of garnish panel 500 and covered surface 605 of vehicle body 600. A second channel 615 is defined below garnish seal 518 between garnish panel 500 covered surface 505.

It will be noted that upper flange 545 is shown in FIG. 6. However, the portion of upper flange 545 in the cross-section shown in FIG. 6 does not extend the entire distance to covered surface 605 of vehicle body 600. See the stepped configuration of upper flange 545 in FIG. 5. This stepped configuration of upper flange 545 provides a gradual seal against vehicle body 600, in order to smooth out the flow of air through entering the labyrinth. This may further reduce wind noise.

Also shown in FIG. 6 is locating feature 540 extending inward from inner surface 625 of garnish panel 500, through main body 519 of garnish seal 518. Locating feature 540 aligns garnish seal 518 with respect to garnish panel 500, ensuring that garnish seal 518 is properly positioned with respect to vehicle body 600 when garnish panel 500 is mounted on the vehicle.

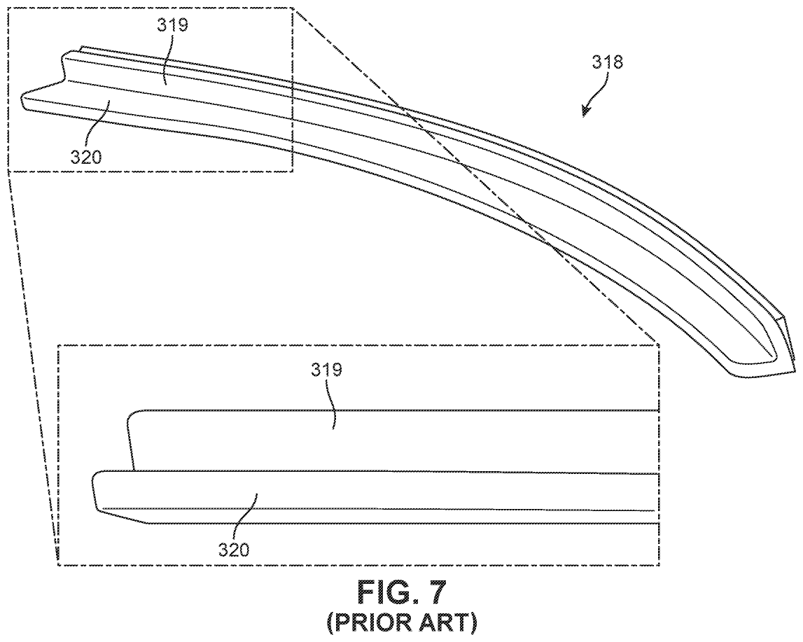

FIG. 7 is a schematic perspective view of the prior art garnish seal shown in FIGS. 3 and 4. As shown in FIG. 7, prior art garnish seal 318 is relatively simple, including main body 319 and sealing element 320.

In contrast, FIG. 8 is a schematic perspective view of the exemplary disclosed garnish seal shown in FIGS. 5 and 6. FIG. 8 shows the tortuous pathway, illustrated by an arrow 800, through the labyrinth of garnish seal 518. Further, FIG. 8 shows sealing element 519 extending along main body 519 and protruding therefrom. It can be seen that sealing element includes a sealing edge 805 configured to seal against the body of a vehicle.

In addition, FIG. 8 shows forward flange 550 and upper flange 545. It can be seen that sealing element 820 has a forward end 815. The tortuous pathway exits from behind the garnish panel through a substantially vertical channel defined between forward flange 550 and forward end 815 of sealing element 820.

As also shown in FIG. 8, garnish seal 518 includes an alignment opening 810 configured to receive the locating feature (540) of the garnish panel (500). (See FIGS. 5 and 6 for locating feature 540.) As further shown in FIG. 8, alignment opening 810 is located proximate to upper flange 545 of garnish seal 518. In addition, alignment opening 810 extends through main body 519 of garnish seal 518 at a location under upper flange 545. Locating the alignment feature so close to the labyrinth portion of garnish seal 518, may provide the most precise alignment of air flow regulating portions of garnish seal 518.

While various embodiments have been described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with, or substituted for, any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

We claim:

1. A garnish seal for a vehicle, comprising:
an elongate main body configured to be mounted on an inner side of a garnish panel;
an elongate sealing element extending along the elongate main body and protruding in a direction away from the main body, the sealing element being configured to seal against a body of a vehicle on which the garnish panel is mounted;
a forward flange protruding away from a forward portion of the main body when the garnish seal is mounted on the vehicle and configured to seal against the body of the vehicle in a forward portion of the garnish panel; and
an upper flange extending along a portion of a length of the main body substantially parallel to the sealing element, defining a channel between the upper flange and the sealing element.

2. The garnish seal of claim 1, further including an alignment opening configured to receive a locating feature of the garnish panel.

3. The garnish seal of claim 2, wherein the alignment opening is located proximate to the upper flange of the garnish seal.

4. The garnish seal of claim 3, wherein the alignment opening extends through the main body of the garnish seal at a location under the upper flange.

5. The garnish seal of claim 1, wherein the garnish seal defines a vertical channel between the forward flange and a forward edge of the sealing element.

6. A garnish seal arrangement, comprising:
a garnish panel configured to be mounted on a body of a vehicle;
a garnish seal including:
an elongate main body configured to be mounted on an inner side of the garnish panel;
an elongate sealing element extending along the elongate main body and protruding in a direction away from the main body, the sealing element being configured to seal against a body of a vehicle on which the garnish panel is mounted;
a forward flange protruding away from a forward portion of the main body when the garnish seal is mounted on the vehicle and configured to seal against the body of the vehicle in a forward portion of the garnish panel; and
an upper flange extending along a portion of a length of the main body substantially parallel to the sealing element, defining a channel between the upper flange and the sealing element.

7. The garnish seal arrangement of claim 6, wherein the garnish seal is configured to be mounted on a lower portion of the garnish panel.

8. The garnish seal arrangement of claim 6, wherein the garnish panel includes a forward flange; and
wherein the forward flange of the garnish seal is configured to substantially mate with the forward flange of the garnish panel.

9. The garnish seal arrangement of claim 6, wherein the garnish panel includes a locating feature extending inward from an inner surface of the garnish panel; and
wherein the garnish seal includes an alignment opening configured to receive the locating feature of the garnish panel.

10. The garnish seal arrangement of claim 9, wherein the alignment opening is located proximate to the upper flange of the garnish seal.

11. The garnish seal arrangement of claim 10, wherein the alignment opening extends through the main body of the garnish seal at a location under the upper flange.

12. The garnish seal arrangement of claim 6, wherein the garnish seal defines a vertical channel between the forward flange and a forward edge of the sealing element.

13. A vehicle, comprising:
a vehicle body defining a structural periphery of the vehicle; and
a garnish seal arrangement, including:
a garnish panel configured to be mounted on the vehicle body;
a garnish seal including:
an elongate main body configured to be mounted on an inner side of the garnish panel;
an elongate sealing element extending along the elongate main body and protruding in a direction away from the main body, the sealing element being configured to seal against a body of a vehicle on which the garnish panel is mounted;
a forward flange protruding away from a forward portion of the main body when the garnish seal is mounted on the vehicle and configured to seal against the body of the vehicle in a forward portion of the garnish panel; and
an upper flange extending along a portion of a length of the main body substantially parallel to the sealing element, defining a channel between the upper flange and the sealing element.

14. The vehicle of claim 13, wherein garnish seal arrangement is configured to be mounted in a D-pillar region of the vehicle body.

15. The vehicle of claim 13, wherein the garnish seal is configured to be mounted on a lower portion of the garnish panel.

16. The vehicle of claim 13, wherein the garnish panel includes a forward flange; and
wherein the forward flange of the garnish seal is configured to substantially mate with the forward flange of the garnish panel.

17. The vehicle of claim 13, wherein the garnish panel includes a locating feature extending inward from an inner surface of the garnish panel; and
wherein the garnish seal includes an alignment opening configured to receive the locating feature of the garnish panel.

18. The vehicle of claim 17, wherein the alignment opening is located proximate to the upper flange of the garnish seal.

19. The vehicle of claim 18, wherein the alignment opening extends through the main body of the garnish seal at a location under the upper flange.

20. The vehicle of claim 13, wherein the garnish seal defines a vertical channel between the forward flange and a forward edge of the sealing element.
